(19) United States
(12) Patent Application Publication
(10) Pub. No.: US 2021/0024083 A1
(43) Pub. Date: Jan. 28, 2021

(54) METHOD AND DEVICE FOR DETERMINING UNMANNED VEHICLE RUNNING SCENE

(71) Applicant: BEIJING BAIDU NETCOM SCIENCE TECHNOLOGY CO., LTD., Beijing (CN)

(72) Inventors: Gao YU, Beijing (CN); Yan FENG, Beijing (CN)

(21) Appl. No.: 17/020,874

(22) Filed: Sep. 15, 2020

Related U.S. Application Data
(63) Continuation of application No. PCT/CN2019/103323, filed on Aug. 29, 2019.

(30) Foreign Application Priority Data
Feb. 1, 2019 (CN) 201910104851.3

(51) Int. Cl. B60W 60/00; H04W 4/44; G07C 5/00; B60W 30/095

(52) U.S. Cl. CPC B60W 60/001; H04W 4/44; B60W 2556/10; B60W 30/0956; G07C 5/008

(57) ABSTRACT

Embodiments of the present application provide a method and a device for determining an unmanned vehicle running scene. In the method, firstly, a data collection instruction sent by a server is received; then traveling data corresponding to the type of the data to be collected is acquired when the collection condition is met; and finally, the traveling data is sent to the server, so that the server determines and restores a running scene of the unmanned vehicle. Since the data collection instruction is sent by the server, and the corresponding traveling data is collected according to the collection condition and the type of data to be collected, the traveling data is determined according to the data collection instruction, so that the server can acquire the traveling data of the unmanned vehicle according to the data collection instruction, and accurately analyze the running scene of the unmanned vehicle.

### CROSS-REFERENCE TO RELATED APPLICATIONS

The present application is a continuation of International Application No. PCT/CN2019/103323, filed on Aug. 29, 2019, entitled “METHOD AND DEVICE FOR DETERMINING UNMANNED VEHICLE RUNNING SCENE”, which claims priority to the Chinese patent application No. 201910104851.3, filed with CNIPA on Feb. 1, 2019 and entitled “METHOD AND DEVICE FOR DETERMINING UNMANNED VEHICLE RUNNING SCENE”, all content of which are hereby incorporated by reference in their entireties.

### TECHNICAL FIELD

Embodiments of the present application relate to the field of unmanned vehicle technologies and, in particular, to a method and a device for determining an unmanned vehicle running scene.

### BACKGROUND

With the continuous progress of artificial intelligence technology, self-driving technology has also made great progress, and various kinds of unmanned vehicles are favored by more and more users. During the traveling process of an unmanned vehicle, the unmanned vehicle needs to send the running scene of the unmanned vehicle to a cloud server, and the cloud server analyzes the traveling condition of the unmanned vehicle according to the running scene of the unmanned vehicle, to realize the correction of the control of the unmanned vehicle. The running scene of the unmanned vehicle includes information such as traveling time and location, obstacles, and traveling state of the unmanned vehicle.

At present, the existing process of determining the unmanned vehicle running scene is that: the unmanned vehicle collects traveling data of the unmanned vehicle during the traveling and sends the data to the cloud server in real time; after receiving the traveling data sent by the unmanned vehicle, the cloud server needs to analyze the traveling data to determine which running state the unmanned vehicle is in when sending the data, and then analyzes the traveling condition of the unmanned vehicle according to the running state of the unmanned vehicle to obtain the running scene of the unmanned vehicle.

However, the inventors found that there are at least following problems in the prior art: because the unmanned vehicle can collect only the data of the fixed type of the unmanned vehicle in the process of collecting data, the data collected by the cloud server is fixed and lacks variety, and the running scene of the unmanned vehicle cannot be accurately analyzed, resulting in that the cloud server cannot correct the control of the unmanned vehicle accurately.

### SUMMARY

Embodiments of the present application provide a method and a device for determining an unmanned vehicle running scene, so as to solve the technical problem in the prior art that the unmanned vehicle can collect only the data of the fixed type of the unmanned vehicle in the process of collecting data, therefore the data collected by the cloud server is fixed and lacks variety, and the running scene of the unmanned vehicle cannot be accurately analyzed.

In a first aspect, an embodiment of the present application provides a method for determining an unmanned vehicle running scene, where the method is applied to an unmanned vehicle, and includes:

receiving a data collection instruction sent by a server, where the data collection instruction includes a collection condition and a type of data to be collected;

acquiring traveling data corresponding to the type of the data to be collected when the collection condition is met; and

sending the traveling data to the server, so that the server determines and restores a running scene of the unmanned vehicle according to the traveling data.

Based on the above technical content, since the data collection instruction is sent by the server, and the corresponding traveling data is collected according to the collection condition and the type of the data to be collected in the data collection instruction, the traveling data collected by the unmanned vehicle is determined according to the data collection instruction, rather than being fixed as in the prior art, so that the server can acquire the traveling data of the unmanned vehicle according to the data collection instruction, and then accurately analyze the running scene of the unmanned vehicle to realize the accurate control of the unmanned vehicle by the server.

In a possible design, the collection condition includes at least one of a target time, a target obstacle quantity, a target location and a target traveling state; the acquiring the traveling data corresponding to the type of the data to be collected when the collection condition is met, includes: acquiring target data sent by a sensing device of the unmanned vehicle in real time, where the target data includes at least one of a time parameter, an obstacle quantity parameter, a location parameter and a traveling state parameter; determining that the unmanned vehicle meets the collection condition when at least one of the time parameter, the obstacle quantity parameter, the location parameter and the traveling state parameter matches at least one of the target time, the target obstacle quantity, the target location and the target traveling state, and acquiring the traveling data of the unmanned vehicle which corresponds to the type of the data to be collected.

By sending the traveling data to the server only when the collection condition is met, the pressure on the network bandwidth brought by real-time data transmission to the server can be reduced.

In a possible design, the receiving the data collection instruction sent by the server includes: receiving the data collection instruction sent by the server through an over-the-air (OTA) mode at a set time interval.

In a second aspect, an embodiment of the present application provides a method for determining an unmanned vehicle running scene, where the method is applied to a server, and includes:

sending a data collection instruction to an unmanned vehicle, where the data collection instruction includes a collection condition and a type of data to be collected;

receiving corresponding traveling data sent by the unmanned vehicle when the collection condition is met, where the traveling data is acquired by the unmanned vehicle according to the type of the data to be collected; and

determining and restoring a running scene of the unmanned vehicle according to the traveling data.

Based on the above technical content, since the data collection instruction is sent by the server, and the corresponding traveling data is collected according to the collection condition and the type of the data to be collected in the data collection instruction, the traveling data collected by the unmanned vehicle is determined according to the data collection instruction, rather than being fixed as in the prior art, so that the server can acquire the traveling data of the unmanned vehicle according to the data collection instruction, and then accurately analyze the running scene of the unmanned vehicle to realize the accurate control of the unmanned vehicle by the server.

In a possible design, the collection condition includes at least one of a target time, a target obstacle quantity, a target location and a target traveling state; where the traveling data is at least one of a time parameter, an obstacle quantity parameter, a location parameter and a traveling state parameter acquired by the unmanned vehicle from a sensing device of the unmanned vehicle at a set time interval; when at least one of the time parameter, the obstacle quantity parameter, the location parameter and the traveling state parameter matches at least one of the target time, the target obstacle quantity, the target location and the target traveling state, it is determined that the unmanned vehicle meets the collection condition, and the traveling data of the unmanned vehicle which corresponds to the type of the data to be collected is acquired.

In a possible design, the traveling data includes a target identification code corresponding to the collection condition and historical traveling data; the determining and restoring the running scene of the unmanned vehicle according to the traveling data includes: making a query using a pre-stored correspondence between identification codes and collection conditions, and acquiring the collection condition corresponding to the target identification code; determining and generating the running scene of the unmanned vehicle according to the collection condition and the historical traveling data.

Instead of directly sending the data of the collection condition with the historical traveling data, a query is made for the collection condition according to the target identification, which can reduce the volume of the transmission data and improve the data transmission efficiency.

In a possible design, after receiving the corresponding traveling data sent by the unmanned vehicle when the collection condition is met, the method further includes: determining whether a time identification of the traveling data exceeds a set time threshold, where the time identification corresponds to a time when the unmanned vehicle generates the traveling data; if the time identification of the traveling data exceeds the set time threshold, re-executing the step of sending the data collection instruction to the unmanned vehicle.

By re-executing the step of sending the data collection instruction to the unmanned vehicle when it is determined that the time identification of the traveling data exceeds the set time threshold, it can be avoided to receive traveling data with time failure.

In a possible design, the sending the data collection instruction to the unmanned vehicle includes: sending the data collection instruction to the unmanned vehicle through an over-the-air (OTA) mode at a set time interval.

In a third aspect, an embodiment of the present application provides an apparatus for determining an unmanned vehicle running scene, where the apparatus is applied to an unmanned vehicle, and includes:

a collection instruction receiving module, configured to receive a data collection instruction sent by a server, where the data collection instruction includes a collection condition and a type of data to be collected;

a traveling data acquiring module, configured to acquire traveling data corresponding to the type of the data to be collected when the collection condition is met; and

a traveling data sending module, configured to send the traveling data to the server, so that the server determines and restores a running scene of the unmanned vehicle according to the traveling data.

In a possible design, the collection condition includes at least one of a target time, a target obstacle quantity, a target location and a target traveling state; the traveling data acquiring module is specifically configured to: acquire target data sent by a sensing device of the unmanned vehicle at a set time interval, where the target data includes at least one of a time parameter, an obstacle quantity parameter, a location parameter and a traveling state parameter; determine that the unmanned vehicle meets the collection condition when at least one of the time parameter, the obstacle quantity parameter, the location parameter and the traveling state parameter matches at least one of the target time, the target obstacle quantity, the target location and the target traveling state, and acquire the traveling data of the unmanned vehicle which corresponds to the type of the data to be collected.

In a possible design, the collection instruction receiving module is specifically configured to receive the data collection instruction sent by the server through an OTA mode at a set time interval.

In a fourth aspect, an embodiment of the present application provides an apparatus for determining an unmanned vehicle running scene, where the apparatus is applied to a server, and includes:

a collection instruction sending module, configured to send a data collection instruction to an unmanned vehicle, where the data collection instruction includes a collection condition and a type of data to be collected;

a data receiving module, configured to receive corresponding traveling data sent by the unmanned vehicle when the collection condition is met, where the traveling data is acquired by the unmanned vehicle according to the type of the data to be collected; and

a running scene determining module, configured to determine and restore the running scene of the unmanned vehicle according to the traveling data.

In a possible design, the collection condition includes at least one of a target time, a target obstacle quantity, a target location and a target traveling state; where the traveling data is at least one of a time parameter, an obstacle quantity parameter, a location parameter and a traveling state parameter acquired by the unmanned vehicle from a sensing device of the unmanned vehicle at a set time interval; when at least one of the time parameter, the obstacle quantity parameter, the location parameter and the traveling state parameter matches at least one of the target time, the target obstacle quantity, the target location and the traveling state, it is determined that the unmanned vehicle meets the collection condition, and the traveling data of the unmanned vehicle which corresponds to the type of the data to be collected is acquired.

In a possible design, the traveling data includes a target identification code corresponding to the collection condition and historical traveling data; the running scene determining module is specifically configured to: make a query using a pre-stored correspondence between identification codes and collection conditions, and acquire the collection condition corresponding to the target identification code; determine and generate the running scene of the unmanned vehicle according to the collection condition and the historical traveling data.

In a possible design, the apparatus further includes: a time threshold determining module, configured to determine whether a time identification of the traveling data exceeds a set time threshold, where the time identification corresponds to a time when the unmanned vehicle generates the traveling data, and if the time identification of the traveling data exceeds the set time threshold, the step of sending the data collection instruction to the unmanned vehicle is re-executed.

In a possible design, the collection instruction sending module is specifically configured to send the data collection instruction to the unmanned vehicle through an OTA mode at a set time interval.

In a fifth aspect, an embodiment of the present application provides a device for determining an unmanned vehicle running scene, including: at least one processor and a memory; where,

the memory is configured to store computer execution instructions; and

the at least one processor is configured to execute the computer execution instructions stored in the memory, so that the at least one processor executes the method for determining an unmanned vehicle running scene as described in the above first aspect and various possible designs in the first aspect.

In a sixth aspect, an embodiment of the present application provides a device for determining an unmanned vehicle running scene, including: at least one processor and a memory; where,

the memory is configured to store computer execution instructions; and

the at least one processor is configured to execute the computer execution instructions stored in the memory, so that the at least one processor executes the method for determining an unmanned vehicle running scene as described in the above second aspect and various possible designs in the second aspect.

In a seventh aspect, an embodiment of the present application provides a computer-readable storage medium, where the computer-readable storage medium stores computer execution instructions which, when executed by a processor, realize the method for determining an unmanned vehicle running scene as described in the above first aspect and various possible designs in the first aspect.

In an eighth aspect, an embodiment of the present application provides a computer-readable storage medium, where the computer-readable storage medium stores computer execution instructions which, when executed by a processor, realize the method for determining an unmanned vehicle running scene as described in the above second aspect and various possible designs in the second aspect.

In the methods and devices for determining an unmanned vehicle running scene provided by the embodiments, firstly, the data collection instruction sent by the server is received, where the data collection instruction includes the collection condition and the type of the data to be collected; then the traveling data corresponding to the type of the data to be collected is acquired when the collection condition is met; and finally, the traveling data is sent to the server, so that the server determines and restores the running scene of the unmanned vehicle according to the traveling data. Since the data collection instruction is sent by the server, and the corresponding traveling data is collected according to the collection condition and the type of the data to be collected in the data collection instruction, the traveling data collected by the unmanned vehicle is determined according to the data collection instruction, rather than being fixed as in the prior art, so that the server can acquire the traveling data of the unmanned vehicle according to the data collection instruction, and then accurately analyze the running scene of the unmanned vehicle to realize the accurate control of the unmanned vehicle by the server.

### BRIEF DESCRIPTION OF THE DRAWINGS

In order to explain the technical solutions in embodiments of the present application or the prior art more clearly, the drawings used in describing the embodiments or the prior art will be briefly introduced below. Obviously, the drawings in the following description are some embodiments of the present application. For those skilled in the art, other drawings can be obtained based on these drawings without creative efforts.

FIG. 1 is a schematic diagram of a system architecture of a system for determining an unmanned vehicle running scene according to an embodiment of the present application;

FIG. 2 is schematic flowchart I of a method for determining an unmanned vehicle running scene according to an embodiment of the present application;

FIG. 3 is schematic flowchart II of a method for determining an unmanned vehicle running scene according to an embodiment of the present application;

FIG. 4 is schematic flowchart III of a method for determining an unmanned vehicle running scene according to an embodiment of the present application;

FIG. 5 is a schematic flowchart of an interaction process of a method for determining an unmanned vehicle running scene according to an embodiment of the present application;

FIG. 6 is schematic structural diagram I of an apparatus for determining an unmanned vehicle running scene according to an embodiment of the present application;

FIG. 7 is schematic structural diagram II of an apparatus for determining an unmanned vehicle running scene according to an embodiment of the present application; and

FIG. 8 is a schematic diagram of a hardware structure of a device for determining an unmanned vehicle running scene according to an embodiment of the present application.

### DETAILED DESCRIPTION OF THE EMBODIMENTS

In order to make the objectives, technical solutions, and advantages of embodiments of the present application clearer, the technical solutions in the embodiments of the present application will be clearly and comprehensively described with reference to the accompanying drawings in the embodiments of the present application. Obviously, the described embodiments are some embodiments of the present application, rather than all of the embodiments. Based on the embodiments of the present application, all other embodiments obtained by those skilled in the art without creative efforts shall fall within the protection scope of the present application.

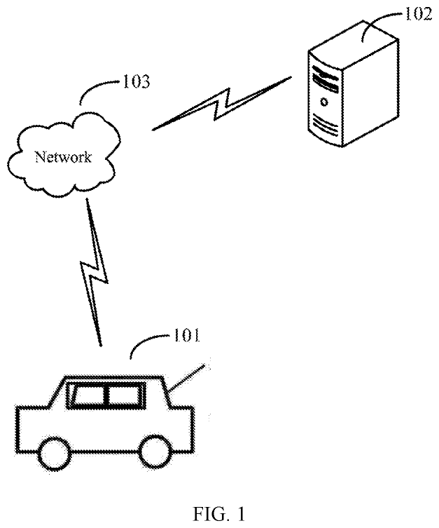

FIG. 1 is a schematic diagram of a system architecture of a system for determining an unmanned vehicle running scene according to an embodiment of the present application. As shown in FIG. 1, the system provided by this embodiment includes an unmanned vehicle 101 and a server 102. The unmanned vehicle 101 and the server 102 communicate with each other through a network 103.

Here, the unmanned vehicle 101 may be equipped with a processor and other sensors, and the sensors are used to sense various states or traveling parameters of the unmanned vehicle.

The server 102 may be a server, a server cluster composed of multiple servers, or a cloud computing platform. The server 102 can realize data transmission with the unmanned vehicle 101 through the network 103 and complete control of the unmanned vehicle 101.

It should be understood that the quantities of the unmanned vehicles 101 and the servers 102 in FIG. 1 are merely exemplary, and any quantity of the unmanned vehicles 101 and the servers 102 can be provided according to needs.

At present, the existing process of determining an unmanned vehicle running scene is that: an unmanned vehicle collects traveling data of the unmanned vehicle during the traveling process and sends the data to a cloud server in real time; after receiving the traveling data sent by the unmanned vehicle, the cloud server needs to analyze the traveling data to determine which running state the unmanned vehicle is in when sending the data, and then analyzes the traveling condition of the unmanned vehicle according to the running state of the unmanned vehicle to obtain the running scene of the unmanned vehicle.

Because the unmanned vehicle can collect only the data of the fixed type of the unmanned vehicle in the process of collecting data, the data collected by the cloud server is fixed and lacks variety, and the running scene of the unmanned vehicle cannot be accurately analyzed, resulting in that the cloud server cannot correct the control of the unmanned vehicle accurately. Embodiments of the present application provide a method and a device for determining an unmanned vehicle running scene, so that traveling data collected by an unmanned vehicle is determined according to a data collection instruction, rather than being fixed as in the prior art, and the server can acquire the traveling data of the unmanned vehicle according to the data collection instruction, and then accurately analyze the running scene of the unmanned vehicle to realize the accurate control of the unmanned vehicle by the server.

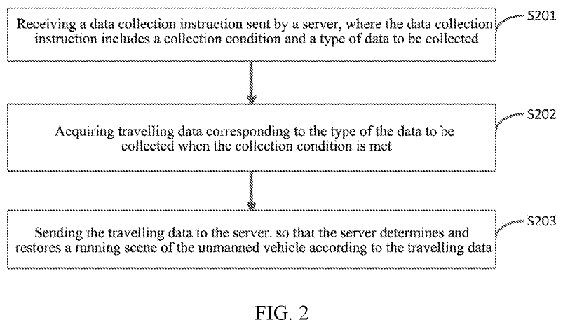

FIG. 2 is schematic flowchart I of a method for determining an unmanned vehicle running scene according to an embodiment of the present application. The executive entity of this embodiment may be the unmanned vehicle in the embodiment shown in FIG. 1, which is not particularly limited here in this embodiment. As shown in FIG. 2, the method includes:

Step S201: receiving a data collection instruction sent by a server, where the data collection instruction includes a collection condition and a type of data to be collected.

In this embodiment, the data collection instruction can be determined according to the type of the unmanned vehicle to be confirmed, and the data collection instruction can carry a type identifier of the unmanned vehicle. Each type of unmanned vehicles corresponds to a different data collection instruction. For example, for an unmanned vehicle of type A, the received data collection instruction carries the collection condition and the type of data to be collected for the unmanned vehicle of type A; for an unmanned vehicle of type B, the received data collection instruction carries the collection condition and the type of data to be collected for the unmanned vehicle of type B.

In this embodiment, the collection condition includes a target time, a target obstacle quantity, a target location and a target traveling state and the like of the unmanned vehicle. The target time refers to the traveling time of the unmanned vehicle; the target obstacle quantity refers to the quantity of obstacles detected by a sensor of the unmanned vehicle in the traveling direction; the target location refers to the location where the unmanned vehicle travels; and the target traveling state refers to a state in which the unmanned vehicle is traveling or a braking state.

The unmanned vehicle is provided with various sensing devices for collecting traveling data of the unmanned vehicle, for example, a camera for capturing images, a global positioning system (Global Positioning System, GPS) module for positioning, an acceleration sensor for acquiring the traveling state of the unmanned vehicle, and so on.

The type of data to be collected is used to instruct the unmanned vehicle to acquire traveling data corresponding to the type of data to be collected from various sensing devices provided on the unmanned vehicle.

The type of data to be collected may include types such as a body state data type, an obstacle data type, and a user somatosensory data type. The body state data type is used to instruct the unmanned vehicle to collect various parameters when the unmanned vehicle is running, such as a speed, an acceleration, a direction, and so on; the obstacle data type is used to instruct the unmanned vehicle to collect the quantity, the size and the like of obstacles; and the user somatosensory data type is used to instruct the unmanned vehicle to collect a relative acceleration perceived by the user and the like.

Step S202: acquiring traveling data corresponding to the type of the data to be collected when the collection condition is met.

In this embodiment, the collection condition can include the target time, the target obstacle quantity, the target position, and the target traveling state.

Specifically, the process of determining whether the unmanned vehicle meets the collection condition may be that:

the unmanned vehicle acquires a time parameter, an obstacle quantity parameter, a location parameter and a traveling state parameter from the sensing devices of the unmanned vehicle at a set interval, and determines that the unmanned vehicle meets the collection condition when the time parameter, the obstacle quantity parameter, the location parameter and the traveling state parameter are consistent with the target time, the target obstacle quantity, the target location and the target traveling state.

The process of determining whether the unmanned vehicle meets the collection condition may also be:

acquiring target data sent by the sensor devices of the unmanned vehicle in real time, where the target data includes at least one of the time parameter, the obstacle quantity parameter, the location parameter and the traveling state parameter; determining that the unmanned vehicle meets the collection condition when at least one of the time parameter, the obstacle quantity parameter, the location parameter and the traveling state parameter matches at least one of the target time, the target obstacle quantity, the target location and the target traveling state.

Specifically, the process of acquiring the traveling data corresponding to the type of the data to be collected may be:

acquiring each type identifier in the type of data to be collected; determining, according to each type identifier, a sensor corresponding to the each type identifier; sending a collection instruction to the sensor corresponding to each type identifier, and control each sensor to collect traveling data corresponding to each type identifier; receiving the traveling data corresponding to each type identifier collected by each sensor. The type of data to be collected may include types such as the body state data type, the obstacle data types, and the user somatosensory data type.

Step S203: sending the traveling data to the server, so that the server determines and restores a running scene of the unmanned vehicle according to the traveling data.

In this embodiment, the traveling data includes body state data, obstacle data, user somatosensory data and the like of the unmanned vehicle. By extracting the body state data, the obstacle data, the user somatosensory data and the like, the running scene of the unmanned vehicle is obtained, where the running scene of the unmanned vehicle refers to the running time and location information of the unmanned vehicle, the situation of obstacles outside the unmanned vehicle, including the quantity, the size and the like of obstacles, and the state of the user, etc.

It can be known from the foregoing description that in this embodiment, firstly, the data collection instruction sent by the server is received, where the data collection instruction includes the collection condition and the type of data to be collected; then the traveling data corresponding to the type of the data to be collected is acquired when the collection condition is met; and finally, the traveling data is sent to the server, so that the server determines and restores the running scene of the unmanned vehicle according to the traveling data. Since the data collection instruction is sent by the server, and the corresponding traveling data is collected according to the collection condition and the type of the data to be collected in the data collection instruction, the traveling data collected by the unmanned vehicle is determined according to the data collection instruction, rather than being fixed as in the prior art, so that the server can acquire the traveling data of the unmanned vehicle according to the data collection instruction, and then accurately analyze the running scene of the unmanned vehicle to realize the accurate control of the unmanned vehicle by the server.

In an embodiment of the present application, the collection condition includes at least one of the target time, the target obstacle quantity, the target location, and the target traveling state; in the embodiment corresponding to FIG. 2, the process of acquiring the traveling data corresponding to the type of the data to be collected when the collection condition is met in step S202, includes:

acquiring target data sent by a sensing device of the unmanned vehicle in real time, where the target data includes at least one of a time parameter, an obstacle quantity parameter, a location parameter, and a traveling state parameter;

determining that the unmanned vehicle meets the collection condition when at least one of the time parameter, the obstacle quantity parameter, the location parameter and the traveling state parameter matches at least one of the target time, the target obstacle quantity, the target location and the target traveling state, and acquiring the traveling data of the unmanned vehicle which corresponds to the type of the data to be collected.

That at least one of the time parameter, the obstacle quantity parameter, the location parameter and the traveling state parameter matches at least one of the target time, the target obstacle quantity, the target location and the target traveling state, refers to that one or more parameters of the time parameter, the obstacle quantity parameter, the location parameter and the traveling state parameter are the same as the one or more corresponding parameters of the target time, the target obstacle quantity, the target location and the target traveling state.

It can be known from the above embodiment that by sending the traveling data to the server only when the collection condition is met, the pressure on the network bandwidth brought by real-time data transmission to the server can be reduced.

For example, the collection condition is that the unmanned vehicle is in the target time of A, the obstacle quantity is 0, the target location is the place B, and the target traveling state is “emergency braking”. When the unmanned vehicle detects that the various parameters obtained from various sensing devices meet that the target time is A, the obstacle quantity is 0, the target location is the place B, and the target traveling state is “emergency braking”, it is determined that the unmanned vehicle meets the collection, and at this time, the traveling data of the unmanned vehicle which corresponds to the type of the data to be collected is acquired.

In an embodiment of the present application, the receiving the data collection instruction sent by the server in step S201 in the embodiment corresponding to FIG. 2 includes:

receiving the data collection instruction sent by the server through an over-the-air (OTA) mode at a set time interval.

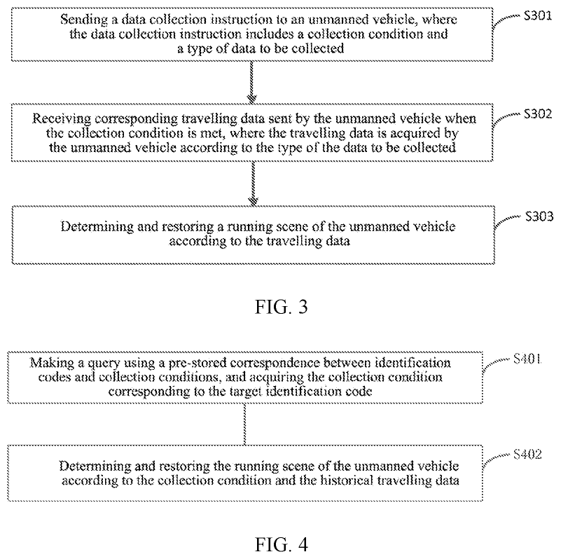

FIG. 3 is a schematic flowchart II of a method for determining an unmanned vehicle running scene according to an embodiment of the present application. The executive entity of this embodiment may be the server in the embodiment shown in FIG. 1, which is not particularly limited in this embodiment. As shown in FIG. 3, the method includes:

Step S301: sending a data collection instruction to an unmanned vehicle, where the data collection instruction includes a collection condition and a type of data to be collected.

Step S302: receiving corresponding traveling data sent by the unmanned vehicle when the collection condition is met, where the traveling data is acquired by the unmanned vehicle according to the type of the data to be collected.

Step S303: determining and restoring a running scene of the unmanned vehicle according to the traveling data.

As can be seen from the above description, in this embodiment, the data collection instruction is sent to the unmanned vehicle, where the data collection instruction includes the collection condition and the type of data to be collected; the corresponding traveling data sent by the unmanned vehicle when the unmanned vehicle meets the collection condition is received, where the traveling data is acquired by the unmanned vehicle according to the type of the data to be collected; and the running scene of the unmanned vehicle is determined and restored according to the traveling data. Since the data collection instruction is sent by the server, and the corresponding traveling data is collected according to the collection condition and the type of the data to be collected in the data collection instruction, the traveling data collected by the unmanned vehicle is determined according to the data collection instruction, rather than being fixed as in the prior art, so that the server can acquire the traveling data of the unmanned vehicle according to the data collection instruction, and then accurately analyze the running scene of the unmanned vehicle to realize the accurate control of the unmanned vehicle by the server.

In an embodiment of the present application, the collection condition includes at least one of a target time, a target obstacle quantity, a target location and a target traveling state; where the traveling data is at least one of a time parameter, an obstacle quantity parameter, a location parameter and a traveling state parameter acquired by the unmanned vehicle from a sensing device of the unmanned vehicle at a set time interval; when at least one of the time parameter, the obstacle quantity parameter, the location parameter and the traveling state parameter matches at least one of the target time, the target obstacle quantity, the target location and the target traveling state, it is determined that the unmanned vehicle meets the collection condition, and the traveling data of the unmanned vehicle which corresponds to the type of the data to be collected is acquired.

FIG. 4 is schematic flowchart III of a method for determining an unmanned vehicle running scene according to an embodiment of the present application. In this embodiment, based on the embodiment of FIG. 3, the traveling data includes a target identification code corresponding to the collection condition and historical traveling data, and the process of determining and generating the running scene of the unmanned vehicle according to the traveling data is described in detail. As shown in FIG. 4, the method includes:

Step S401: making a query using a pre-stored correspondence between identification codes and the collection conditions, and acquiring the collection condition corresponding to the target identification code.

In this embodiment, since there may be multiple collection instructions sent to the unmanned vehicle, in order to determine the collection condition corresponding to the traveling data, the target identification code corresponding to the collection condition with which the unmanned vehicle collects the traveling data as well as historical traveling data are packaged to obtain the traveling data. After receiving the traveling data, the target identification code is extracted; a query is made using the pre-stored correspondence between identification codes and collection conditions according to the target identification code, and the collection condition corresponding to the target identification code is acquired.

For example, refer to Table 1. Table 1 is an example of a pre-stored correspondence between identification codes and collection conditions.

TABLE 1
An example of a pre-stored correspondence between
identification codes and collection conditions

| Identification Code | Collection Condition |
|---|---|
| 01 | Target time 1, target obstacle quantity 1, target |
| | location 1 and target travelling state 1 |
| 02 | Target time 2, target obstacle quantity 2, target |
| | location 2 and target travelling state 2 |
| 03 | Target time 3, target obstacle quantity 4, target |
| | location 4 and target travelling state 4 |

Step S402: determining and generating the running scene of the unmanned vehicle according to the collection condition and the historical traveling data.

In this embodiment, the historical traveling data may include body state data, obstacle data, and user somatosensory data. The collection condition includes the target time, the target obstacle quantity, the target location, and the target traveling state of the unmanned vehicle. By extracting the body state data, the obstacle data, the user somatosensory data and the like, the running scene of the unmanned vehicle is obtained, where the running scene of the unmanned vehicle refers to the running time and location information of the unmanned vehicle, the situation of obstacles outside the unmanned vehicle, including the quantity, the size and the like of obstacles, and the state of the user, etc.

It can be known from the above description that instead of directly sending the data of the collection condition with the historical traveling data, a query is made for the collection condition according to the target identification, which can reduce the volume of the transmission data and improve the data transmission efficiency.

In an embodiment of the present application, after receiving the corresponding traveling data sent by the unmanned vehicle when the collection condition is met, the method further includes:

determining whether a time identification of the traveling data exceeds a set time threshold, where the time identification corresponds to a time when the unmanned vehicle generates the traveling data; and

if the time identification of the traveling data exceeds the set time threshold, re-executing the step of sending the data collection instruction to the unmanned vehicle.

In this embodiment, since the control of the unmanned vehicle is in real time, a certain failure time must not be exceeded for the received traveling data, otherwise the received traveling data cannot represent the current traveling state of the unmanned vehicle.

It can be known from the above description that by re-executing the step of sending the data collection instruction to the unmanned vehicle when it is determined that the time identification of the traveling data exceeds the set time threshold, it can be avoided to receive traveling data with time failure.

In an embodiment of the present application, the sending the data collection instruction to the unmanned vehicle includes:

sending the data collection instruction to the unmanned vehicle through an OTA mode at a set time interval.

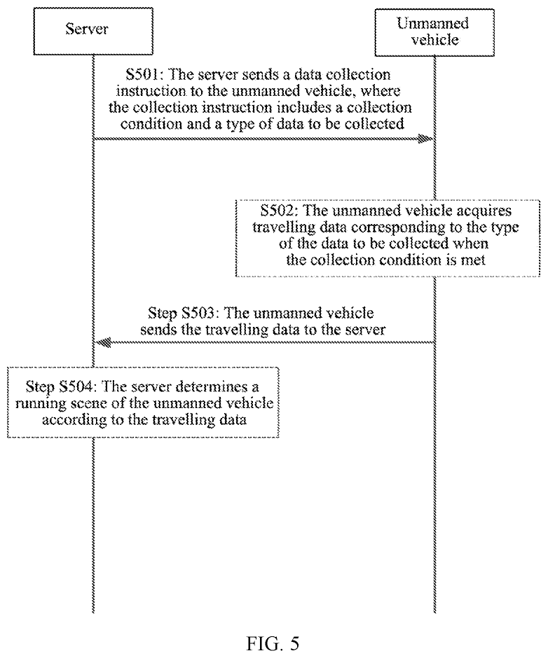

FIG. 5 is a schematic flowchart of an interaction process of a method for determining an unmanned vehicle running scene according to an embodiment of the present application. An interaction process between an unmanned vehicle and a server is described in this embodiment, but it is not particularly limited here in this embodiment. As shown in FIG. 5, the method includes:

Step S501: the server sends a data collection instruction to the unmanned vehicle, where the collection instruction includes a collection condition and a type of data to be collected.

Step S502: The unmanned vehicle acquires traveling data corresponding to the type of the data to be collected when the collection condition is met.

Step S503: The unmanned vehicle sends the traveling data to the server.

Step S504: The server determines a running scene of the unmanned vehicle according to the traveling data.

As can be seen from the above description, since the data collection instruction is sent by the server, and the corresponding traveling data is collected according to the collection condition and the type of the data to be collected in the data collection instruction, the traveling data collected by the unmanned vehicle is determined according to the data collection instruction, rather than being fixed as in the prior art, so that the server can acquire the traveling data of the unmanned vehicle according to the data collection instruction, and then accurately analyze the running scene of the unmanned vehicle to realize the accurate control of the unmanned vehicle by the server.

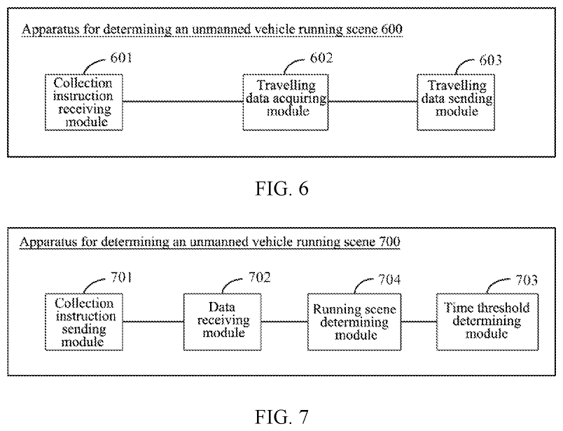

FIG. 6 is schematic structural diagram I of an apparatus for determining an unmanned vehicle running scene according to an embodiment of the present application. As shown in FIG. 6, the apparatus for determining an unmanned vehicle running scene 600 includes a collection instruction receiving module 601, a traveling data acquiring module 602, and a traveling data sending module 603.

The collection instruction receiving module 601 is configured to receive a data collection instruction sent by a server, where the data collection instruction includes a collection condition and a type of data to be collected;

the traveling data acquiring module 602 is configured to acquire traveling data corresponding to the type of the data to be collected when the collection condition is met; and

the traveling data sending module 603 is configured to send the traveling data to the server, so that the server determines and restores a running scene of the unmanned vehicle according to the traveling data.

The device provided in this embodiment can be used to execute the technical solution of the method embodiment corresponding to FIG. 2, and their implementation principles and technical effects are similar, which will not be repeated here in this embodiment.

In an embodiment of the present application, the collection condition includes at least one of a target time, a target obstacle quantity, a target location and a target traveling state.

The traveling data acquiring module 602 is specifically configured to: acquire target data sent by a sensing device at a set time interval, where the target data includes at least one of a time parameter, an obstacle quantity parameter, a location parameter and a traveling state parameter; determine that the unmanned vehicle meets the collection condition when at least one of the time parameter, the obstacle quantity parameter, the location parameter and the traveling state parameter matches at least one of the target time, the target obstacle quantity, the target location and the target traveling state, and acquire the traveling data of the unmanned vehicle which corresponds to the type of the data to be collected.

In an embodiment of the present application, the collection instruction receiving module 601 is specifically configured to receive the data collection instruction sent by the server through an OTA mode at a set time interval.

FIG. 7 is schematic structural diagram II of an apparatus for determining an unmanned vehicle running scene according to an embodiment of the present application. As shown in FIG. 7, the apparatus for determining an unmanned vehicle running scene 700 includes:

a collection instruction sending module 701, configured to send a data collection instruction to an unmanned vehicle, where the data collection instruction includes a collection condition and a type of data to be collected;

a data receiving module 702, configured to receive corresponding traveling data sent by the unmanned vehicle when the collection condition is met, where the traveling data is acquired by the unmanned vehicle according to the type of the data to be collected; and

a running scene determining module 703, configured to determine and restore a running scene of the unmanned vehicle according to the traveling data.

The device provided in this embodiment can be used to execute the technical solution of the method embodiment corresponding to FIG. 3, and their implementation principles and technical effects thereof are similar, which will not be repeated here in this embodiment.

In an embodiment of the present application, the collection condition includes at least one of a target time, a target obstacle quantity, a target location and a target traveling state; where the traveling data is at least one of a time parameter, an obstacle quantity parameter, a location parameter and a traveling state parameter acquired by the unmanned vehicle from a sensing device of the unmanned vehicle at a set time interval; when at least one of the time parameter, the obstacle quantity parameter, the location parameter and the traveling state parameter matches at least one of the target time, the target obstacle quantity, the target location and the target traveling state, it is determined that the unmanned vehicle meets the collection condition, and the traveling data of the unmanned vehicle which corresponds to the type of the data to be collected is acquired.

In an embodiment of the present application, the traveling data includes a target identification code corresponding to the collection conditions and historical traveling data.

The running scene determining module 703 is specifically configured to: make a query using a pre-stored correspondence between identification codes and collection conditions, and acquire the collection condition corresponding to the target identification code; determine and generate the running scene of the unmanned vehicle according to the collection condition and the historical traveling data.

In an embodiment of the present application, referring to FIG. 7, the apparatus further includes:

a time threshold determining module 704, configured to determine whether a time identification of the traveling data exceeds a set time threshold, where the time identification corresponds to a time when the unmanned vehicle generates the traveling data, and if the time identification of the traveling data exceeds the set time threshold, the step of sending the data collection instruction to the unmanned vehicle is re-executed.

In an embodiment of the present application, the collection instruction sending module 701 is specifically configured to send the data collection instruction to the unmanned vehicle through an OTA mode at a set time interval.

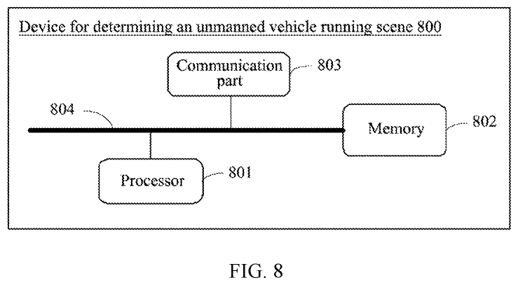

FIG. 8 is a schematic diagram of a hardware structure of a device for determining an unmanned vehicle running scene according to an embodiment of the present application. As shown in FIG. 8, the device for determining an unmanned vehicle running scene 800 provided in this embodiment includes: at least one processor 801 and a memory 802. The device for determining an unmanned vehicle running scene 800 further includes a communication part 803. The processor 801, the memory 802, and the communication part 803 are connected through a bus 804.

In a specific implementation process, the at least one processor 801 executes computer execution instructions stored in the memory 802, so that the at least one processor 801 executes the method for determining an unmanned vehicle running scene in any of the foregoing method embodiments. The communication part 803 is configured to communicate with a terminal device and/or a server.

For the specific implementation process of the processor 801, please refer to the foregoing method embodiments. Their implementation principles and technical effects are similar, which will not be repeated here in this embodiment.

In the embodiment shown in FIG. 8 described above, it should be understood that the processor may be a central processing unit (CPU for short), or other general-purpose processor, digital signal processor (DSP for short), application specific integrated circuit (ASIC for short) or the like. A general-purpose processor may be a microprocessor or the processor may be any conventional processor or the like. The steps of the methods disclosed in combination with the present application can be directly embodied as being performed by a hardware processor, or performed by a combination of hardware and software modules in the processor.

The memory may include a high-speed RAM memory, and may also include a non-volatile storage NVM, such as at least one disk memory.

The bus may be an industry standard architecture (ISA) bus, a peripheral component interconnect (PCI) bus, or an extended industry standard architecture (EISA) bus or the like. The bus can be divided into an address bus, a data bus, a control bus, and the like. For ease of representation, the bus in the drawings of the present application is not limited to only one bus or one type of buses.

An embodiment of the present application further provides a computer-readable storage medium, where the computer-readable storage medium stores computer execution instructions which, when executed by a processor, realize the method for determining an unmanned vehicle running scene as described above.

In several embodiments provided in the present application, it will be appreciated that the disclosed devices and methods may be implemented in another manner. For example, the device embodiments described above are only illustrative. For example, division of the modules is only a division of logic functions, and other division manners may be adopted during a practical implementation. For example, multiple modules may be combined or integrated into another system, or some characteristics may be omitted or not executed. In addition, mutual couplings or direct couplings or communication connections shown or discussed may be indirect couplings or communication connections through some interfaces, apparatuses or modules, and may be implemented in electrical, mechanical or other forms.

The modules described as separate parts may be or may not be physically separated. The parts displayed as modules may be or may not be physical units, i.e. the parts may be located in the same place, or may be distributed to multiple network units. Part or all of the modules may be selected, according to a practical requirement, to achieve the objectives of the solutions in the embodiments.

In addition, the functional modules in the embodiments of the present application may be integrated into one processing unit; each module may also physically exist alone; two or more modules may also be integrated into one unit. The above modularized units may be implemented in the form of hardware, or in the form of hardware plus software functional units.

The integrated modules implemented in the form of software functional modules may be stored in a computer-readable storage medium. The above software function modules are stored in a storage medium and include several instructions for causing a computer device (which may be a personal computer, a server, or a network device, etc.) or a processor to execute some steps of the methods described in the embodiments of the present application.

It should be understood that the above processor may be a central processing unit (CPU for short), or other general-purpose processor, digital signal processor (DSP for short), application specific integrated circuit (ASIC for short) or the like. A general-purpose processor may be a microprocessor or the processor may be any conventional processor or the like. The steps of the methods disclosed in combination with the present application can be directly embodied as being performed by a hardware processor, or performed by a combination of hardware and software modules in the processor.

The memory may include a high-speed RAM memory; the memory may also include a non-volatile storage NVM, such as at least one disk memory; and the memory may also be a U disk, a mobile hard disk, a read-only memory, a magnetic disk or an optical disk, etc.

The bus may be an industry standard architecture (ISA) bus, a peripheral component interconnect (PCI) bus, or an extended industry standard architecture EISA) bus or the like. The bus can be divided into an address bus, a data bus, a control bus, and the like. For ease of representation, the bus in the drawings of the present application is not limited to only one bus or one type of buses.

The above storage medium may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk. The storage medium may be any available medium that can be accessed by a general-purpose or special-purpose computer.

An exemplary storage medium is coupled to a processor such that the processor can read information from, and write information to, the storage medium. Of course, the storage medium may also be an integral part of the processor. The processor and the storage medium may be located in an application specific integrated circuit (ASIC for short). Of course, the processor and the storage medium may also exist as discrete components in an electronic device or a master control device.

It will be understood by those skilled in the art that all or part of the steps of implementing the above method embodiments may be performed by hardware related to the program instructions. The aforementioned program can be stored in a computer-readable storage medium. The program performs the steps including the foregoing method embodiments when being executed; and the foregoing storage medium includes various media that can store program codes, such as a ROM, a RAM, a magnetic disk, or an optical disk.

Finally, it should be noted that the above embodiments are only used to explain the technical solutions of the present application and shall not be construed as limitation. Although the present application has been described in detail with reference to the foregoing embodiments, those skilled in the art will understand that the technical solutions described in the foregoing embodiments may be modified, or some or all of the technical features may be equivalently replaced; and such modifications or substitutions do not make the corresponding technical solutions deviate from the scope of the technical solutions of the embodiments of the present application.

What is claimed is:

1. A method for determining an unmanned vehicle running scene, wherein the method is applied to an unmanned vehicle, and comprises:
receiving a data collection instruction sent by a server, wherein the data collection instruction comprises a collection condition and a type of data to be collected;
acquiring traveling data corresponding to the type of the data to be collected when the collection condition is met; and
sending the traveling data to the server, so that the server determines and restores a running scene of the unmanned vehicle according to the traveling data.

2. The method according to claim 1, wherein the collection condition comprises at least one of a target time, a target obstacle quantity, a target location and a target traveling state;
the acquiring traveling data corresponding to the type of the data to be collected when the collection condition is met comprises:
acquiring target data sent by a sensing device of the unmanned vehicle in real time, wherein the target data comprises at least one of a time parameter, an obstacle quantity parameter, a location parameter and a traveling state parameter;
determining that the unmanned vehicle meets the collection condition when at least one of the time parameter, the obstacle quantity parameter, the location parameter and the traveling state parameter matches at least one of the target time, the target obstacle quantity, the target location and the target traveling state, and acquiring the traveling data of the unmanned vehicle which corresponds to the type of the data to be collected.

3. The method according to claim 1, wherein the receiving a data collection instruction sent by a server comprises:
receiving the data collection instruction sent by the server through an over-the-air (OTA) mode at a set time interval.

4. A method for determining an unmanned vehicle running scene, wherein the method is applied to a server, and comprises:
sending a data collection instruction to an unmanned vehicle, wherein the data collection instruction comprises a collection condition and a type of data to be collected;
receiving corresponding traveling data sent by the unmanned vehicle when the collection condition is met, wherein the traveling data is acquired by the unmanned vehicle according to the type of the data to be collected; and
determining and restoring a running scene of the unmanned vehicle according to the traveling data.

5. The method according to claim 4, wherein the collection condition comprises at least one of a target time, a target obstacle quantity, a target location and a target traveling state; wherein the traveling data is at least one of a time parameter, an obstacle quantity parameter, a location parameter and a traveling state parameter acquired by the unmanned vehicle from a sensing device of the unmanned vehicle at a set time interval; when at least one of the time parameter, the obstacle quantity parameter, the location parameter and the traveling state parameter matches at least one of the target time, the target obstacle quantity, the target location and the target traveling state, it is determined by the unmanned vehicle that the unmanned vehicle meets the collection conditions, and the traveling data of the unmanned vehicle which corresponds to the type of the data to be collected is acquired by the unmanned vehicle.

6. The method according to claim 4, wherein the traveling data comprises a target identification code corresponding to the collection condition and historical traveling data;
the determining and restoring a running scene of the unmanned vehicle according to the traveling data comprises:
making a query using a pre-stored correspondence between identification codes and collection conditions, and acquiring the collection condition corresponding to the target identification code; and
determining and generating the running scene of the unmanned vehicle according to the collection condition and the historical traveling data.

7. The method according to claim 4, after receiving the corresponding traveling data sent by the unmanned vehicle when the collection condition is met, further comprising:
determining whether a time identification of the traveling data exceeds a set time threshold, wherein the time identification corresponds to a time when the unmanned vehicle generates the traveling data; and
if the time identification of the traveling data exceeds the set time threshold, re-executing the step of sending the data collection instruction to the unmanned vehicle.

8. The method according to claim 4, wherein the sending a data collection instruction to an unmanned vehicle comprises:
sending the data collection instruction to the unmanned vehicle through an over-the-air (OTA) mode at a set time interval.

9. A device for determining an unmanned vehicle running scene, wherein the device is applied to an unmanned vehicle, and comprises at least one processor and a memory, wherein,
the memory is configured to store computer execution instructions; and
the at least one processor is configured to execute the computer execution instructions stored in the memory, so that the at least one processor is configured to:
receive a data collection instruction sent by a server, wherein the data collection instruction comprises a collection condition and a type of data to be collected;
acquire traveling data corresponding to the type of the data to be collected when the collection condition is met; and
send the traveling data to the server, so that the server determines and restores a running scene of the unmanned vehicle according to the traveling data.

10. The device according to claim 9, wherein the collection condition comprises at least one of a target time, a target obstacle quantity, a target location and a target traveling state;
the at least one processor is specifically configured to: acquire target data sent by a sensing device of the unmanned vehicle at a set time interval, wherein the target data comprises at least one of a time parameter, an obstacle quantity parameter, a location parameter and a traveling state parameter; determine that the unmanned vehicle meets the collection condition when at least one of the time parameter, the obstacle quantity parameter, the location parameter and the traveling state parameter matches at least one of the target time, the target obstacle quantity, the target location and the target traveling state, and acquire the traveling data of the unmanned vehicle which corresponds to the type of the data to be collected.

11. The device according to claim 9, wherein the at least one processor is specifically configured to receive the data collection instruction sent by the server through an over-the-air (OTA) mode at a set time interval.

12. A device for determining an unmanned vehicle running scene, comprising: at least one processor and a memory; wherein,
the memory is configured to store computer execution instructions; and
the at least one processor is configured to execute the computer execution instructions stored in the memory, so that the at least one processor executes the method for determining an unmanned vehicle running scene according to claim 4.

13. The device according to claim 12, wherein the collection condition comprises at least one of a target time, a target obstacle quantity, a target location and a target traveling state; wherein the traveling data is at least one of a time parameter, an obstacle quantity parameter, a location parameter and a traveling state parameter acquired by the unmanned vehicle from a sensing device of the unmanned vehicle at a set time interval; when at least one of the time parameter, the obstacle quantity parameter, the location parameter and the traveling state parameter matches at least one of the target time, the target obstacle quantity, the target location and the target traveling state, it is determined by the unmanned vehicle that the unmanned vehicle meets the collection conditions, and the traveling data of the unmanned vehicle which corresponds to the type of the data to be collected is acquired by the unmanned vehicle.

14. The device according to claim 12, wherein the traveling data comprises a target identification code corresponding to the collection condition and historical traveling data;
the at least one processor executes:
making a query using a pre-stored correspondence between identification codes and collection conditions, and acquiring the collection condition corresponding to the target identification code; and
determining and generating the running scene of the unmanned vehicle according to the collection condition and the historical traveling data.

15. The device according to claim 12, wherein after receiving the corresponding traveling data sent by the unmanned vehicle when the collection condition is met, the at least one processor further executes:
determining whether a time identification of the traveling data exceeds a set time threshold, wherein the time identification corresponds to a time when the unmanned vehicle generates the traveling data; and
if the time identification of the traveling data exceeds the set time threshold, re-executing the step of sending the data collection instruction to the unmanned vehicle.

16. The device according to claim 12, wherein the at least one processor executes:
sending the data collection instruction to the unmanned vehicle through an over-the-air (OTA) mode at a set time interval.

17. A computer-readable storage medium, wherein the computer-readable storage medium stores computer execution instructions which, when executed by a processor, realize the method for determining an unmanned vehicle running scene according to claim 1.

18. A computer-readable storage medium, wherein the computer-readable storage medium stores computer execution instructions which, when executed by a processor, realize the method for determining an unmanned vehicle running scene according to claim 4.
